(19) United States
(12) Patent Application Publication
(10) Pub. No.: US 2009/0218256 A1
(43) Pub. Date: Sep. 3, 2009

(54) Double Wall Separating Drum

(76) Inventor: Karsten Rasmussen, Gentofte (DK)

Correspondence Address: JAMES C. WRAY, 1493 CHAIN BRIDGE ROAD, SUITE 300, MCLEAN, VA, 22101, US

(21) Appl. No.: 12/226,828

(22) PCT Filed: Apr. 30, 2007
(86) PCT No.: PCT/DK2007/000205

§ 371 Date: Jan. 21, 2009

(30) Foreign Application Priority Data
May 1, 2006 (DK) PA 2006 00612

(51) Int. Cl. B07B 1/26

(52) U.S. Cl. 209/286; 209/291

(57) ABSTRACT

Separating device, comprising a rotatable double walled separating drum, where a first wall of the drum constituting the inner drum (2) is arranged concentrically inside and space from a second wall constituting the outer drum (3) of the separating drum, and that a plurality of apertures are provided in said drum walls, where the apertures in the first wall have larger openings than the apertures in the second wall, and that the axis about which the drum rotates may be arranged at an inclined angle in relation to a horizontal plane.

### FIELD OF THE INVENTION

The present invention is directed to a separating device, which separating device may be used to separate pulverised or particular material from sheets; sheets made from for example paper or other similar materials. Furthermore, the invention relates to an apparatus for regenerating materials where the separating device is integrated in the apparatus.

### BACKGROUND OF THE INVENTION

Separation techniques for separation of wet material like drilling mud are widely described. As an example GB 2,061,750A describes how contaminated drilling mud is cleaned within two hollow open-ended co-axial frusto-conical parts under the influence of vibrations. Separation of wet material is based on a principle of separating small particles from a fluid substance, hence the size of the apertures of the walls have to be extremely small and function like a mesh in order to function properly. This indicates that the separation technique functions as a filter, which is moved either by rotation or vibration in order for the separation to function efficiently. As a filter easily chokes the fluid phase of the separation material is essential. However, the use of fluid in order to achieve proper separation of dry material would destroy for example gypsum.

In applicant's prior patent application EP 142,995 an apparatus was described for recycling in particular gypsum, but also other materials comprising a hydraulic binder in combination with other materials. This application is hereby incorporated by reference.

During the development of the prior art device, a relatively good separation of the gypsum from the other materials was achieved. It was however desirable to be able to improve the efficiency both with respect to productivity, but also separation of the different materials into cleaner fractions, i.e. fractions only containing one type of material.

### OBJECT OF THE INVENTION

It is therefore an object of the present invention to provide a separating device for separation of arid material without the use of fluid, which will improve the quality of the separation, and at the same time improve the quantity of material which may be treated in the separating device.

### DESCRIPTION OF THE INVENTION

The invention addresses this by providing a separating device comprising a rotatable double walled separating drum, where a first wall of the drum constituting the inner drum is arranged concentrically inside and space from a second wall constituting the outer drum of the separating drum, and that a plurality of apertures are provided in said drum walls, where the apertures in the first wall have larger openings than the apertures in the second wall, and that the axis about which the drum rotates may be arranged at an inclined angle in relation to a horizontal plane.

By providing two drums where the apertures provided in each drum are of different sizes, a surprisingly increased quality of the materials separated in the device is achieved. By having the larger apertures in the inner drum loose fractions of the material, for example gypsum, may relatively quickly be separated from the entire material mass such that the rest of the materials' travel through the drum will be carried out with a substantially larger part of the remaining material in contact with this inner surface of the drum such that it becomes easier for separated material to leave the inner drum and thereby the material mass.

The outer drum provided with smaller apertures will also allow a substantially larger part of the material to pass through the wall of the drum and at the same time the rotation of the separating drum, i.e. both the inner and outer drum will, due to the mechanical impacts of the materials against the wall of the drums during the materials travel inside the separating device, continuously reduce the size of the material fractions, i.e. the gypsum, such that an increasingly larger part of the desired material will be able to travel through the drum walls of the separating device. At the same time, other materials such as for example paper or cardboard which is used for creating the plates known as gypsum plates or plaster boards will relatively quickly be separated from the gypsum, both as the material, i.e. the gypsum, passes the inner drum wall and especially the outer drum wall. In this manner it is also possible to get a cleaner fraction of paper or cardboard such that when storing this or when burning it, for example in an incinerator the amount of pollution in this part deriving from gypsum or other hydraulic binder materials will be relatively low such that the quality of the material is increased. Also, the quality of the resulting separated gypsum is greatly improved.

By furthermore arranging the drums to rotate about an axle which is arranged at an inclined angle in relation to the horizontal plane, gravity will cause the material inside the drum to travel through the drum and thereby consistently make space for added material to the separating device.

Tests with different sizes and shapes of apertures in the drum walls have indicated that the shape of the apertures only has a very limited effect, such that in further advantageous embodiments of the invention, the apertures in the first wall and the second wall have any suitable shape, such as circular, oval, polygonal or a slit configuration.

Of greater importance is the size of the apertures provided in the wall of the drums. For this purpose, the apertures in the first wall are provided with an equivalent opening corresponding to from ø 20 mm to ø 50 mm, more preferred ø 25 mm to ø 40 and most preferred ø 30 mm, and that the apertures in the second wall has an equivalent opening corresponding to ø 3 mm to ø 18 mm, more preferred ø 6 mm to ø 15 mm, and most preferred ø 10 mm.

The formulation “equivalent opening corresponding to” is intended to mean that the area of for example an aperture having a diameter of 40 mm when being a rectangular, oval or any other geometrical shape should have the same opening area. Having openings as defined above provides for a relatively good separation of the polarized material in relation to the sheet materials such that for example paper, card board or the like.

Also, a further important aspect of the invention relating in particular to the productivity of the separating device is the overall dimensions of the separating device. The overall size shall also be considered in relation to the forces for rotating the drums and the shear amount of material, material strength and rigidity of the construction. For a number of purposes as will be further explained below, it is advantageous that the diameter of the outer drum is between ø 1800 mm and ø 1000 mm, more preferred between ø 1500 mm and ø 1300 mm. This, for example, in combination with the further features that the length of the separating drum is between 12000 mm and 8000 mm, more preferred between 10000 mm and 9000 mm provides for a good compromise between being able to separate enough material in the drum, and at the same time the separating device having a size where it may be built on to a trailer, and thereby becoming a mobile unit. In connection with the applicant's prior device mentioned above, this is an important alternative embodiment in that the mobility of the plant from an economic point of view is important.

In a further advantageous embodiment, regardless of the size of the apertures and their shape, between 60% to 90%, more preferred 70% to 80% of the surfaces of each of both the inner and outer drums are apertures, and that optionally radial or circular stiffeners may be provided in order to provide the required rigidity of the separating drum. In this manner, the drums have a very large open surface such that a substantial amount of material separated by the mechanical action of the rotating drums may be brought to pass through the apertures provided in the drum walls.

In a further advantageous embodiment, the separating drum rotates at 2 to 10 revolutions per minute, more preferred 4 to 8 revolutions per minute, about its axis of rotation, and where optionally the inner drum may rotate at a different speed than the outer drum, and optionally in opposite directions of rotation, and in a still further advantageous embodiment a vibration generator is in vibrating contact with at least one of the inner or outer drums, for vibrating said drum(s), and/or that nozzles providing high pressure jets of air are provided inside the separating device, where the jets mainly blows in a direction against the inclination and/or rotation of the drum. The rotation speed for example in combination with vibrations further improves the separating process due to mechanical interaction between the wall of the drums the apertures and the material placed inside the drums.

The invention also provides for an apparatus for regenerating materials comprising a hydraulic binder, in particular gypsum, wherein the apparatus comprises a hopper arranged in connection with means for providing a coarse crushing of materials introduced into the hopper, and further that the means for coarse crushing is in connection with a first conveying means, which conveys the coarse crushed material to an inlet opening for a roller mill device, where the coarse crushed material is rolled, after which a second conveyor means conveys the material to a separating device characterised in that the separating device comprises a rotating double walled separating drum, where a first wall of the drum is arranged concentrically inside and space from a second wall of the drum, and that a plurality of apertures are provided in said drum walls, where the apertures in the first wall are larger than the apertures in the second wall, and that the axis about which the drum rotates is arranged at an inclined angle in relation to a horizontal plane, where the apertures allow the crushed and milled fine particles to pass through the apertures and be collected in a third conveyor means for reuse or alternatively storage, and that the material left in the drum, both inside the first wall and the second wall is collected by means of a fourth conveyor means, and is further transported away for storage or disposal. This apparatus substantially corresponds to the apparatus in the applicant's prior art patent as mentioned above where the resulting quantity and quality of regenerated material is improved by use of the new separating device according to the present invention.

The double wall construction of the separation device provides for the possibility of collecting materials from the inner and outer drums separately whereby a grading of the finished material in a first quality and second quality may be achieved.

### DESCRIPTION OF THE DRAWING

The invention will now be explained with reference to the accompanying drawing wherein

FIG. 1 is a perspective view of a separating device according to the invention,

FIG. 2 illustrates a schematic cross section perpendicular to the rotation axis,

FIG. 3 illustrates the separating device integrated in an apparatus for regenerating materials.

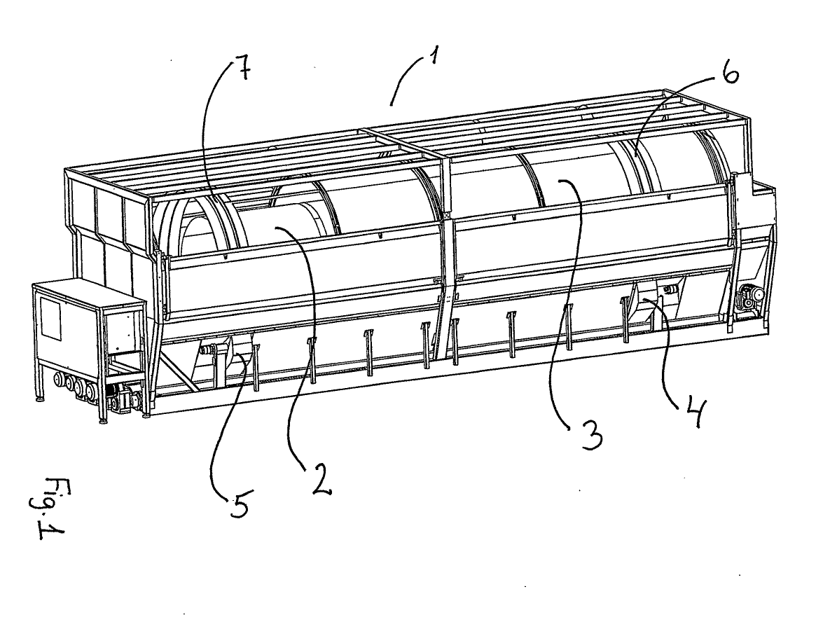

FIG. 1 illustrates a perspective view of a separating device according to the invention. In this embodiment, the separating device 1 comprises an inner drum 2 and an outer drum 3. For illustrative purposes, the outer drum has been depicted as being shorter than the inner drum 2, but in most embodiments the inner and outer drum will have the same extension lengthwise. In order to rotate the separating device, drive means 4, 5 are provided which, by engaging drive rails 6, 7, creates the desired rotation of the drums 2, 3.

Underneath the drum construction is a collecting conveyor which is provided lengthwise in order to collect the pulverised material which has passed through the apertures provided in the walls of the drums 2, 3. As may further be deducted from the illustration in FIG. 1, the drums 2, 3 are arranged at an inclined angle in relation to horizontal such that gravity will propel the material placed in the separating device through the drums to the end opposite the input end.

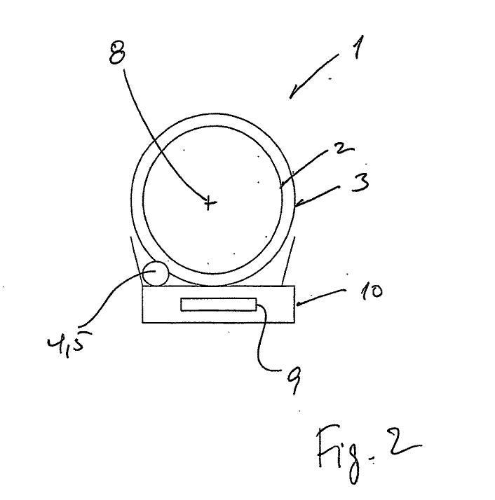

Turning to FIG. 2, a schematic illustration of a cross section through a separating device is illustrated.

In FIG. 2, the separating device 1 is shown in a very schematic way in order to illustrate the important features of the device. The inner drum 2 is concentrically arranged within the outer drum 3 for rotation about a common axis 8. Drive means, here illustrated by an engaging wheel 4, 5, are provided in order to rotate the drums 2, 3 such that material placed inside the inner drum 2 will, due to mechanical abrasion, be separated and at least partly pulverised and enter the space between the two drums 2, 3 for further mechanical abrasion and separation such that eventually, a substantially pure material fraction will be able to pass the apertures provided in the outer drums 3 walls and be collected on a longitudinally arranged conveyor 9. The conveyor 9 is in this embodiment arranged in a substructure 10 which will not be described in detail as this has no influence on the proper working of the inventive separating device.

On the surface of the inner drum 2, materials having a size larger than the apertures provided in the inner drum will be collected. When the waste material to be regenerated, i.e. separated, is gypsum plates, and in particular plaster boards, the plaster boards are constructed by applying paper or cardboard on either side of a layer of gypsum in order to provide a certain integrity to the plaster board. During regeneration, the plaster board will, as described in the applicant's prior patent, be crushed such that a coarsely crushed material may be arranged inside the separating device. The particles of the crushed material will typically comprise paper or cardboard and adhered to one surface of the paper or cardboard a substantial amount of gypsum. The exercise for the separating device according to the present invention is to separate and pulverise the gypsum part of the plaster board from the paper or cardboard. This is done by rotating the drums 2, 3 such that the gypsum will separate from the paper due to mechanical abrasion, and as the gypsum is separated it will pass through the apertures in the inner drum and engage the inner wall of the outer drum 3 for further pulverisation. In this manner, the cardboard/paper will agglomerate on the inner drum and may be collected and disposed of in any suitable manner. In the space between the inner and outer drums 2, 3 a substantial amount of gypsum will collect, but also smaller pieces of card board or paper will be present in this material mass. Due to the smaller size of the apertures in the walls of the outer drum 3 and the mechanical abrasion due to rotation of the drums, a further pulverisation will occur such that the outer material, which will eventually pass through the outer wall of the outer drum 3 on to the conveyor 9, will be substantially free from foreign materials such as cardboard or paper. This in turn leaves a relatively clean paper/cardboard material rest inside the inner drum 2 and a smaller fraction comprising particles, which have been able to travel though the apertures provided in the wall of the inner drum, will be collected in the space between the inner drum 2 and the outer drum 3.

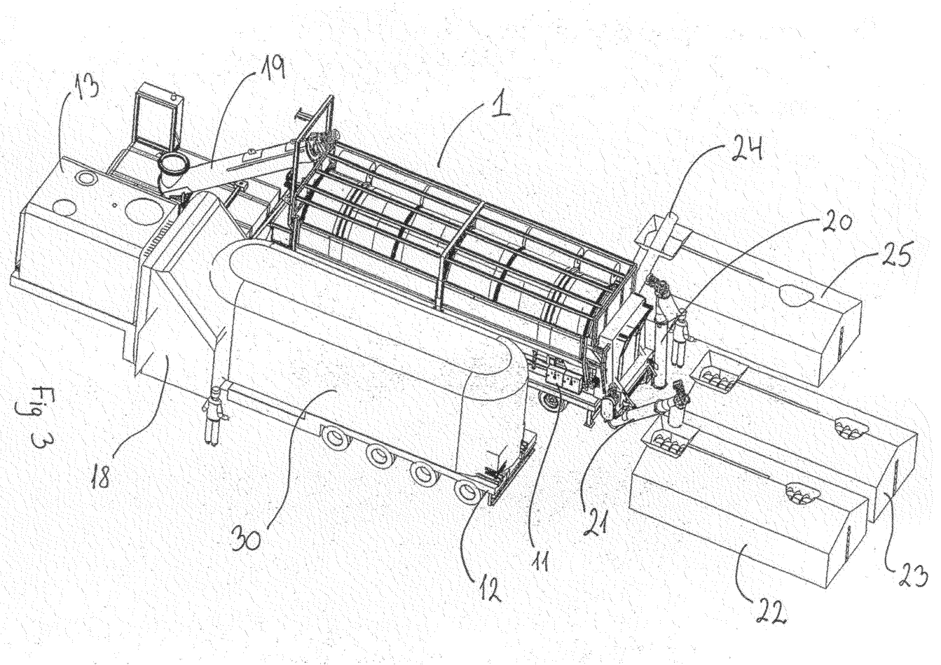

In FIG. 3 is illustrated an apparatus in which a separating device 1 is integrated. In this embodiment, the apparatus is arranged on two trailers 11, 12 such that it is possible to move the apparatus onto a site in order to process materials on site.

The apparatus comprises a power station 13 which will deliver the necessary power in order to carry out the processes. In this connection, power may be electrical power, hydraulic power, pneumatic or any other suitable source of power which will provide the optimum according to the different machines arranged in the apparatus.

An inlet hopper 14 is provided on the trailer 12. In the inlet hopper a first crushing device is arranged. In order to minimise the impact on the immediate environment, both with respect to noise and dust, the crushers are covered by a substantially air tight cover 30.

The coarsely crushed material leaves the crushing device by means of snail conveyors 16, 17 (not illustrated) and may be introduced to further crushing in a second crushing device 18. From the second crusher 18, a further snail conveyor 19 introduces the crushed material into the separating device 1 according to the present invention.

The separating device is arranged in an inclined angle to horizontal such that the force of gravity will transport the material through the separating device 1 from the inlet adjacent the snail conveyor 19 to the outlet in the opposite end. During the transport through the separating device 1, mechanical abrasion will pulverise the gypsum plates such that, as described above, a substantially pure fraction of gypsum will be the result at the end of the separating device 1. This fraction is by means of further screw conveyors 20, 21 transported into containers 22, 23 which may easily be transported to a desired location. The separated paper fraction which will be present inside the inner drum 2 and possibly in the space between the inner and outer drum 2, 3 is by means of a further screw conveyor 24 transferred to a paper collection container 25. In this manner, the material introduced into the inlet hopper 14 being worked through the apparatus, as described, will end up in two fractions, a first substantially pure gypsum fraction and a second paper fraction.

Due to the tariffs on depositing waste in landfill sites, it is much cheaper to deposit paper which may be incinerated, and reuse the gypsum fraction for example for producing further building materials or as fillers in other construction materials, than to deposit the unworked gypsum plaster plates.

For illustrative purposes, the apparatus has been illustrated without the exterior cover. In practice, an exterior cover will be provided around both trailers in order to minimise the impact of dust arising from the crushing and separating process to the immediate environment. For this purpose, a filter unit 26 may be provided such that a substantial under pressure inside the covering of the trailers will be maintained, and that any exhaust air will be filtered such that small particles will not enter the atmosphere.

1. Dry separating device for dry material, comprising a rotatable double walled separating drum, where a first wall of the drum constituting the inner drum is arranged concentrically inside and space from a second wall constituting the outer drum of the separating drum, and that a plurality of apertures are provided in said drum walls, where the apertures in the first wall have larger openings than the apertures in the second wall, and that the axis about which the drum rotates may be arranged at an inclined angle in relation to a horizontal plane.

2. Separating device according to claim 1 wherein the apertures in the first wall and the second wall have any suitable shape, such as circular, oval, polygonal or a slit configuration.

3. Separating device according to claim 1, wherein the apertures in the first wall have an equivalent opening corresponding to from ø 20 mm to ø 50 mm, more preferred ø 25 mm to ø 40 and most preferred ø 30 mm, and that the apertures in the second wall have an equivalent opening corresponding to ø 3 mm to ø 18 mm, more preferred ø 6 mm to ø 15 mm, and most preferred ø 10 mm.

4. Separating device according to claim 1, wherein the diameter of the outer drum is between ø 2500 mm and ø 2000 mm, more preferred between ø 2300 mm and ø 2200 mm, and that the diameter of the inner drum is between ø 1800 mm and ø 1000 mm, more preferred between ø 1500 mm and ø 1300 mm.

5. Separating device according to claim 1 wherein the length of the separating drum is between 12000 mm and 8000 mm, more preferred between 10000 mm and 9000 mm.

6. Separating device according to claim 1 wherein between 60% to 90%, more preferred 70% to 80% of the surfaces of each of both the inner and outer drums are apertures, and that optionally radial or circular stiffeners may be provided in order to provide the required rigidity of the separating drum.

7. Separating device according to claim 1 wherein the separating drum rotates at 2 to 10 revolutions per minute, more preferred 4 to 8 revolutions per minute, about its axis of rotation and where optionally the inner drum may rotate at a different speed than the outer drum, and optionally in opposite directions of rotation.

8. Separating device according to claim 1 wherein a vibration generator is in vibrating contact with at least one of the inner or outer drums, for vibrating said drum(s), and/or that nozzles providing high pressure jets of air are provided inside the separating device, where the jets mainly blow in a direction against the inclination and/or rotation of the drum.

9. Apparatus for regenerating materials comprising a hydraulic binder, in particular gypsum, wherein the apparatus comprises a hopper arranged in connection with means for providing a coarse crushing of materials introduced into the hopper, and further that the means for coarse crushing is in connection with a first conveying means, which conveys the coarse crushed material to an inlet opening for a roller mill device where the coarse crushed material is rolled, after which a second conveyor means conveys the material to a separating device wherein the separating device comprises a rotating double walled separating drum, where a first wall of the drum is arranged concentrically inside and space from a second wall of the drum, and that a plurality of apertures are provided in said drum walls, where the apertures in the first wall are larger than the apertures in the second wall, and that the axis about which the drum rotates is arranged at an inclined angle in relation to a horizontal plane, where the apertures allow the crushed and milled fine particles to pass through the apertures and be collected in a third conveyor means for reuse or alternatively storage, and that the material left in the drum, both inside the first wall and the second wall is collected by means of a fourth conveyor means, and is further transported away for storage or disposal.

10. Apparatus according to claim 9, wherein the material left inside the first wall is collected separately and that material left between the first wall and the second wall is collected separately.
